(19) United States
(12) Patent Application Publication
(10) Pub. No.: US 2007/0236642 A1
(43) Pub. Date: Oct. 11, 2007

(54) Liquid crystal display with driving chip attached on light guide plate thereof

(75) Inventors: Xin-Sheng Chen, Shenzhen (CN); Guo-Hua Yu, Shenzhen (CN); Yu-Hsun Jen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/784,901

(22) Filed: Apr. 9, 2007

(30) Foreign Application Priority Data
Apr. 7, 2006 (TW) 95112487

(51) Int. Cl. G02F 1/1345

(52) U.S. Cl. 349/149

(57) ABSTRACT

An exemplary liquid crystal display (1) includes a first liquid crystal panel (12), a second liquid crystal panel (18), a light guide plate (14) between the first and second liquid crystal panels, and a driving chip (16) located on the light guide plate. The driving chip is electrically connected to the first and second liquid crystal panels and is configured for driving the first and second liquid crystal panels.

### FIELD OF THE INVENTION

The present invention relates to a double-sided liquid crystal display that includes a driving chip attached on a light guide plate thereof, the driving chip being for driving dual liquid crystal panels of the liquid crystal display.

### GENERAL BACKGROUND

Liquid crystal displays are commonly used as display devices for compact electronic apparatuses, because they not only provide good quality images but are also very thin.

Referring to FIG. 6, a typical double-sided liquid crystal display 5 includes an upper liquid crystal panel 51, a backlight module 52, and a lower liquid crystal panel 53, arranged in that order from top to bottom. The upper liquid crystal panel 51 includes a first lower substrate (not labeled) having a first driving chip 512 bonded thereon. The first driving chip 512 is for driving the upper liquid crystal panel 51. The lower liquid crystal panel 53 includes a second lower substrate (not labeled) having a second driving chip 532 bonded thereon. The second driving chip 532 is for driving the lower liquid crystal panel 53.

The backlight module 52 is located between the upper liquid crystal panel 51 and the lower liquid crystal panel 53. The backlight module 52 includes a light guide plate 522, and an illuminator 524 disposed adjacent to a side edge of the light guide plate 522. The backlight module 52 can provide a planar light source for the upper and lower liquid crystal panels 51, 53. Thus, the liquid crystal display 5 can achieve dual display.

The upper and lower liquid crystal panels 51, 53 are respectively driven by the first and second driving chips 512, 532. That is, the two driving chips 512, 532 are needed for each liquid crystal display 5. In addition, steps of bonding the first and second driving chips 512, 532 respectively to the first and second lower substrates 51, 53 are needed during manufacturing of the liquid crystal display 5. This limits the efficiency of manufacturing of the liquid crystal display 5. The above-described factors contribute to the cost of the liquid crystal display 5.

What is needed, therefore, is a liquid crystal display that can overcome the above-described limitations or deficiencies.

### SUMMARY

In one preferred embodiment, a liquid crystal display includes a first liquid crystal panel, a second liquid crystal panel, a light guide plate between the first and second liquid crystal panels, and a driving chip bonded on the light guide plate. The driving chip is electrically connected to the first and second liquid crystal panels, and is configured (i.e., structured and arranged) for driving the first and second liquid crystal panels.

Other novel features, advantages and aspects will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is a side view of a double-sided liquid crystal display according to a first embodiment of the present invention, the liquid crystal display including a first liquid crystal panel, a second liquid crystal panel, and a light guide plate sandwiched between the liquid crystal panels.

FIG. 2 is an enlarged, side cross-sectional view of part of the first liquid crystal panel, the light guide plate and the second liquid crystal panel of the liquid crystal display of FIG. 1.

FIG. 3 is an abbreviated top view of certain components of the first liquid crystal panel of FIG. 1, including circuitry thereof.

FIG. 4 is an exploded, isometric view of the liquid crystal display of FIG. 1, viewed from another aspect.

FIG. 5 is an isometric view of a light guide plate of a double-sided liquid crystal display according to a second embodiment of the present invention.

FIG. 6 is an exploded, side view of a conventional liquid crystal display.

### DETAILED DESCRIPTION OF PREFERRED EMBODIMENTS

Reference will now be made to the drawings to describe preferred embodiments of the present invention in detail. In this description, unless the context indicates otherwise, a reference to a “line” is a reference to an electrically conductive line.

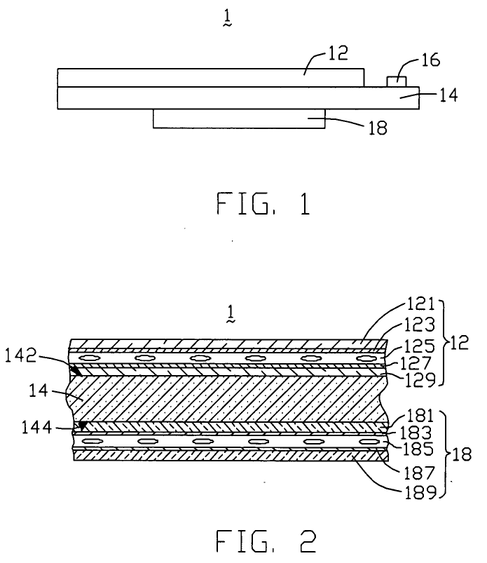

Referring to FIG. 1, a double-sided liquid crystal display 1 according to a first embodiment of the present invention is shown. The liquid crystal display 1 includes an upper liquid crystal panel 12, a light guide plate 14, and a lower liquid crystal panel 18, arranged in that order from top to bottom. The liquid crystal display 1 also includes a driving chip 16. The driving chip 16 is located on a portion of the light guide plate 14 adjacent the upper liquid crystal panel 12.

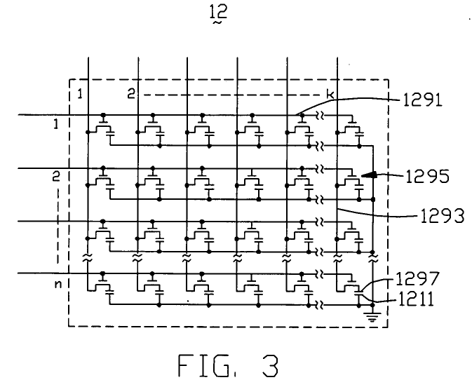

Referring also to FIG. 2, the upper liquid crystal panel 12 includes a first substrate 121, a first polarizing film 123, a first liquid crystal layer 125, a second polarizing film 127, and a second substrate 129, arranged in that order from top to bottom.

Referring also to FIG. 3, the second substrate 129 includes a number n (where n is a natural number) of scanning lines 1291 that are parallel to each other and that each extend along a first direction, and a number k (where k is also a natural number) of signal lines 1293 that are parallel to each other and that each extend along a second direction orthogonal to the first direction. The second substrate 129 also includes a plurality of thin film transistors (TFTs) 1295 that function as switching elements. The second substrate 129 further includes a plurality of pixel electrodes 1297 formed on a surface thereof facing the first substrate 121. Each TFT 1295 is provided in the vicinity of a respective point of intersection of the scanning lines 1291 and the signal lines 1293.

Each TFT 1295 includes a gate electrode, a source electrode, and a drain electrode. The gate electrode of the TFT 1295 is connected to the corresponding scanning line 1291. The source electrode of the TFT 1295 is connected to the corresponding signal line 1293. The drain electrode of the TFT 1295 is connected to a corresponding pixel electrode 1297.

The first substrate 121 includes a plurality of common electrodes 1211 opposite to the pixel electrodes 1297. In particular, the common electrodes 1211 are formed on a surface of the first substrate 121 that faces the second substrate 129, and are made from transparent material such as Indium-Tin Oxide (ITO) or the like. A pixel electrode 1297, a common electrode 1211 facing the pixel electrode 1297, and liquid crystal molecules of the first liquid crystal layer 125 between the two electrodes 1297, 1211 cooperatively define a single pixel unit.

The lower liquid crystal panel 18 has a structure similar to that described above in relation to the upper liquid crystal panel 12. In particular, a third substrate 181 of the lower liquid crystal panel 18 resembles the second substrate 129, and a fourth substrate 189 of the lower liquid crystal panel 18 resembles the first substrate 121.

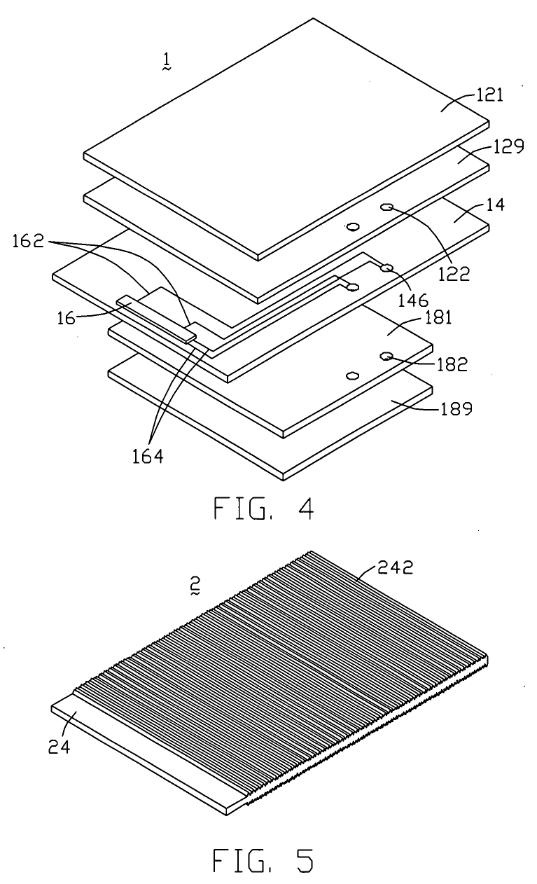

Referring also to FIG. 4, the second substrate 129 also includes a plurality of first through holes 122 located at an edge portion (not labeled) thereof. In the illustrated embodiment, there are two first through holes 122. The first and second polarizing films 123, 127 are respectively attached to surfaces (not labeled) of the first and second substrates 121, 129 that are nearest to the first liquid crystal layer 125. Thus, there is no need to protect the first and second polarizing films 123, 127 from being scraped. That is, there is no need for conventional protective layers.

The lower liquid crystal panel 18 includes the third substrate 181, a third polarizing film 183, a second liquid crystal layer 185, a fourth polarizing film 187, and the fourth substrate 189, arranged in that order from top to bottom. The third substrate 181 includes a plurality of second through holes 182 located at an edge portion (not labeled) thereof. In the illustrated embodiment, there are two second through holes 182. The third and fourth polarizing films 183, 187 are respectively attached to surfaces (not labeled) of the third and fourth substrates 181, 189 that are nearest to the second liquid crystal layer 185. Thus, there is no need to protect the third and fourth polarizing films 183, 187 from being scraped. That is, there is no need for conventional protective layers.

The light guide plate 14 includes a first light emitting surface 142 closely abutting the second substrate 129 of the upper liquid crystal panel 12, and a second light emitting surface 144 closely abutting the third substrate 181 of the lower liquid crystal panel 18. Typically, the light guide plate 14 is made from glass. The light guide plate 14 also includes a plurality of third through holes 146 located at an edge portion (not labeled) thereof. Each third through hole 146 corresponds to a respective one of the first through holes 122 and a respective one of the second through holes 182. In the illustrated embodiment, there are two third through holes 146. A plurality of first electrically conductive lines 162 and a plurality of second electrically conductive lines 164 are respectively located at the edge portions of the first light emitting surface 142, and are electrically connected to the driving chip 16 by an anisotropic conductive film (not shown). In the illustrated embodiment, there are two first lines 162 and two second lines 164.

Typically, the driving chip 16 is bonded on the first light emitting surface 142 of the light guide plate 14 by a chip-on-glass (COG) method. The driving chip 16 includes a scanning driving circuit (not visible) and a signal driving circuit (not visible) therein. The scanning lines 1291 of the second substrate 129 are connected to the scanning driving circuit via the first lines 162, which extend through the first through holes 122. The scanning lines (not shown) of the third substrate 181 are connected to the scanning driving circuit also via the first lines 162, which also extend through the third through holes 146 and the second through holes 182. The signal lines 1293 of the second substrate 129 are connected to the signal driving circuit via the second lines 164, which also extend through the first through holes 122. The signal lines (not shown) of the third substrate 181 are connected to the signal driving circuit also via the second lines 164, which also extend through the third through holes 146 and the second through holes 182. Thus, the upper liquid crystal panel 12 and the lower liquid crystal panel 18 can be respectively and simultaneously driven by the driving chip 16. Furthermore, the driving chip 16 can be configured to emit light when it is supplied with an appropriate voltage. In such case, the driving chip 16 also serves as a light source to illuminate an adjacent side edge of the light guide plate 14.

With the above-described configuration, the upper and lower liquid crystal panels 12, 18 can be respectively and simultaneously driven by the driving chip 16 bonded on the light guide plate 14. Unlike in conventional art, there is no need to bond one driving IC on the second substrate 129 and then another driving IC on the third substrate 181. Thus, only one driving chip 16 is needed for each liquid crystal display 1. In addition, an efficiency of manufacturing of the liquid crystal display 1 can be improved. For at least these reasons, the cost of the liquid crystal display 1 can be reduced. Furthermore, the first, second, third and fourth polarizing films 123, 127, 183, 187 are located within the respective upper and lower liquid crystal panels 12, 18. Thus, there is no need for conventional protective layers, and a total thickness of the liquid crystal display 1 can be reduced.

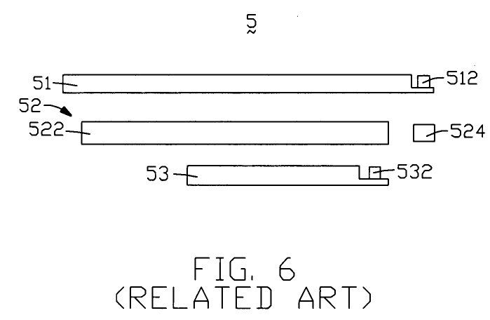

Referring to FIG. 5, a double-sided liquid crystal display 2 according to a second embodiment of the present invention is similar to the liquid crystal display 1. However, the liquid crystal display 2 includes a light guide plate 24 having two opposite light emitting surfaces (not labeled). The light emitting surfaces respectively abut an upper liquid crystal panel (not shown) and a lower liquid crystal panel (not shown) of the liquid crystal display 2. A plurality of diffusing micro-structures 242 are formed on each of the light emitting surfaces, for improving a uniformity of light output by the light guide plate 24 to each of the liquid crystal panels. Accordingly, the quality of images viewed on the liquid crystal panels of the liquid crystal display 2 can be improved. The diffusing micro-structures 242 can be formed by a laser-etching method. In other respects, the liquid crystal display 2 has advantages similar to those described above in relation to the liquid crystal display 1.

Further or alternative embodiments may include the following. In one example, the second and third polarizing films 127, 183 can be attached to surfaces of the second and third substrates 129, 181 that are farthest from the respective first and second liquid crystal layers 125, 185. In another example, the driving chip 16 can be bonded on the second light emitting surface 144 of the light guide plate 14.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A liquid crystal display comprising:
a first liquid crystal panel;
a second liquid crystal panel;
a light guide plate between the first and second liquid crystal panels; and
a driving chip located on the light guide plate, the driving chip being electrically connected to the first and second liquid crystal panels and configured for driving the first and second liquid crystal panels.

2. The liquid crystal display as claimed in claim 1, wherein the first liquid crystal panel comprises a first substrate abutting a first light emitting surface of the light guide plate.

3. The liquid crystal display as claimed in claim 2, wherein the second liquid crystal panel comprises a second substrate abutting a second light emitting surface of the light guide plate.

4. The liquid crystal display as claimed in claim 3, wherein the first substrate comprises a plurality of first through holes thereat, and the second substrate comprises a plurality of second through holes thereat, and the light guide plate comprises a plurality of third through holes thereat, each third through hole corresponding to a respective one of the first through holes and a respective one of the second through holes.

5. The liquid crystal display as claimed in claim 4, wherein the first, second and third through holes are located at respective edges portions of the first substrate, the second substrate, and the light guide plate.

6. The liquid crystal display as claimed in claim 3, wherein the driving chip is located on the first light emitting surface of the light guide plate.

7. The liquid crystal display as claimed in claim 6, wherein the light guide plate is made from glass.

8. The liquid crystal display as claimed in claim 7, wherein the driving chip is bonded on the first light emitting surface of the light guide plate.

9. The liquid crystal display as claimed in claim 6, wherein a plurality of first electrically conductive lines and second electrically conductive lines are located at the first light emitting surface of the light guide plate.

10. The liquid crystal display as claimed in claim 9, wherein the driving chip is electrically connected to the first lines and the second lines.

11. The liquid crystal display as claimed in claim 10, wherein the first lines and the second lines are electrically connected to the first liquid crystal panel via the first through holes, and electrically connected to the second liquid crystal panel via the third through holes and the second through holes.

12. The liquid crystal display as claimed in claim 1, wherein the driving chip is configured to emit light when it is supplied with an appropriate voltage, such that the driving chip serves as a light source to illuminate an adjacent side edge of the light guide plate.

13. The liquid crystal display as claimed in claim 1, wherein at least one of the first and second light emitting surfaces comprises a plurality of diffusing micro-structures formed thereat.

14. The liquid crystal display as claimed in claim 13, wherein the diffusing micro-structures are laser-etched diffusing micro-structures.

15. The liquid crystal display as claimed in claim 1, wherein the driving chip is configured for driving the first and second liquid crystal panels simultaneously.

16. The liquid crystal display as claimed in claim 3, wherein the driving chip is located on the second light emitting surface of the light guide plate.

17. A liquid crystal display comprising:
a first liquid crystal panel having a plurality of first through holes;
a second liquid crystal panel having a plurality of second through holes;
a light guide plate between the first and second liquid crystal panels, the light guide plate having a plurality of third through holes; and
a driving chip located at the light guide plate, the driving chip being electrically connected to the first and second liquid crystal panels via selected of the first, second, and third through holes.

18. The liquid crystal display as claimed in claim 17, wherein each third through hole corresponds to a respective one of the first through holes and a respective one of the second through holes.

19. The liquid crystal display as claimed in claim 17, wherein the driving chip is configured to emit light when it is supplied with an appropriate voltage, such that the driving chip serves as a light source to illuminate an adjacent side edge of the light guide plate.
